(19) United States
(12) Patent Application Publication
(10) Pub. No.: US 2026/0077689 A1
(43) Pub. Date: Mar. 19, 2026

(54) VEHICLE SEAT

(71) Applicant: Adient US LLC, Plymouth, MI (US)

(72) Inventors: Joachim KÄMMERER, Kaiserslautern (DE); Andre BÖHM, Kaiserslautern (DE); Ralph RECKTENWALD, Freisen (DE); Holger KUNZ, Otterberg (DE); Andreas WIESEMANN, Kaiserslautern (DE)

(21) Appl. No.: 19/332,187

(22) Filed: Sep. 18, 2025

(30) Foreign Application Priority Data
Sep. 19, 2024 (DE) 10 2024 209 008.5

(51) Int. Cl. B60N 2/12

(52) U.S. Cl. CPC B60N 2/12

(57) ABSTRACT

A vehicle seat may have a seat part, a backrest, a kinematic system for shifting the vehicle seat from a position of use into an entry position and back again, a longitudinal adjustment device for longitudinally adjusting the vehicle seat, and an entry position stop that is configured to absorb in the entry position a force acting upon the backrest and to run free to provide an emergency exit.

### FIELD

The invention relates to a vehicle seat comprising at least one seat part, a backrest, a kinematic system for shifting the vehicle seat from a position of use into an entry position and back again, a longitudinal adjustment device for longitudinally adjusting the vehicle seat, and an entry position stop.

### BACKGROUND

Known in the prior art are various easy-entry systems that make it easier to enter a second row of seats in a vehicle. The easy-entry system is actuatable by a release lever, which is usually arranged on a backrest of the vehicle seat, the backrest of the vehicle seat pivoting out of an entry region. If the vehicle seat is arranged on rails, the vehicle seat may additionally or alternatively be displaceable out of the entry region in the direction of travel upon actuation of the release lever.

When the vehicle seat is being shifted from the position of use into the easy-entry position, both a backrest fitting and a longitudinal seat lock are released. The releasing of the backrest fitting allows the backrest of the vehicle seat to be pivoted forward in the direction of a seat part of the vehicle seat, while the releasing of the longitudinal seat lock allows the entire vehicle seat to be pushed forward in the direction of travel. This gives a vehicle occupant access to the rear seats of the vehicle.

### SUMMARY

The invention is based on the object of improving a vehicle seat of the type mentioned at the outset, in particular to provide a vehicle seat that is shiftable from a position of use into an entry position, and from the position of use to the entry position, or to an emergency exit position, in order to provide an emergency exit, with few components and thus reduced costs.

This object is achieved according to the invention by a vehicle seat having the features of claim 1.

The vehicle seat according to the invention comprises at least one seat part, a backrest, a kinematic system for shifting the vehicle seat from a position of use into an entry position and back again, a longitudinal adjustment device for longitudinally adjusting the vehicle seat, and an entry position stop. The entry position stop is configured to absorb in the entry position a force acting upon the backrest and to run free for the purpose of providing an emergency exit.

Since the entry position stop is configured to absorb in the entry position a force acting upon the backrest, the kinematic system, for example a spindle drive unit of the kinematic system for shifting the vehicle seat between the position of use and the entry position, can be relieved of forces acting upon the backrest. The service life of the vehicle seat can thus be increased, and mechanical stress on both the kinematic system and the backrest can be reduced. The vehicle seat may be shiftable from the position of use into the entry position by means of an electric motor drive.

Since the entry position stop is configured to run freely in order to provide an emergency exit, the shifting of the vehicle seat into an entry position, or into an emergency exit position, can be ensured with the vehicle seat being in any longitudinal position. To provide the emergency exit, the vehicle seat may be shiftable from the position of use into the entry position, also known as the emergency exit position, by means of an electric motor and/or manually. The free running of the entry position stop prevents the shifting of the vehicle seat from the position of use into the entry position, or to the emergency exit position, from being blocked.

Advantageous designs, which may be used individually or in combination with each other, constitute the subject-matter of the dependent claims.

The kinematic system may have, for example, at least one pair of rockers and a spindle drive unit for adjusting the pair of rockers in order to bring the vehicle seat from the position of use into the entry position, in particular an easy-entry position. In the entry position, which can be assumed multiple times during vehicle use, the vehicle seat must in each case be able to bear a load of, for example, 650 N on an upper side of the backrest. Such a load can result in a very high load on the spindle drive.

By means of the entry position stop, in particular in the form of an easy-entry end stop, the load on the spindle drive can be reduced. Without such an entry position stop, a large spindle diameter would be required to enable such loads, or forces, to be absorbed. The design or use of such spindle drive units can result in increased costs and installation space requirements. In order to reduce costs and installation space, the entry position stop is provided, which is configured to absorb a force acting upon the backrest.

The entry position stop may comprise at least one stop that is arranged in a pivotable manner on a rocker of the kinematic system and at least one counter-stop that is fixedly connected to a fixed rail element of the longitudinal adjustment device.

The stop may be realized so as to be pivotable in a first direction from an initial position into a stop position. The stop may be realized so as to be pivotable in a second direction from the initial position into a free-running position. For example, the first direction corresponds to a clockwise rotational movement. The second direction may correspond to an anti-clockwise rotational movement. In particular, the stop may be realized so as to be pivotable about an axis of rotation of the rocker.

In order to prevent the stop and the counter-stop from coming into blocking or obstructive contact in any longitudinal position in which the vehicle seat is to be shifted from its position of use into the entry position, for example in the case of a manual emergency exit, it is provided according to the invention that the entry position stop, in particular the stop, can run freely for the purpose of providing the emergency exit. The stop may be moved away counter to the direction of rotation of the rocker and into free-running. This enables the vehicle seat, in a longitudinal position that goes beyond a position of the counter stop and/or another longitudinal position, to be shiftable from the position of use into the entry position, or into the emergency exit position. The free-running prevents the stop from coming into blocking contact with a rail cover and/or other objects in the region of the longitudinal adjustment device.

The counter-stop may be arranged in the region of a front longitudinal position, for example a longitudinal setting position, of the longitudinal adjustment device. The counter-stop may comprise at least a vertically extending first counter-stop face and a horizontally extending second counter-stop face. The counter-stop may be composed of a profiled element and a facing. The counter-stop may be realized in the form of a block and/or solid.

The movement for shifting the vehicle seat from a position of use into the entry position may be a combined movement of the kinematic system and the longitudinal adjustment device. At least one movable rail element of the longitudinal adjustment device and the kinematic system may be moved electronically in parallel or sequentially. In the entry position, the vehicle seat, in particular the seat part and the backrest, is pivoted forward to facilitate access to a rear row of seats. By means of the longitudinal adjustment device, the vehicle seat may additionally be displaced forward to assume the entry position. The longitudinal adjustment device may comprise at least one pair of rails having a fixed rail element and a rail element that is movable relative to the fixed rail element.

In the entry position, the vehicle seat may be displaced into the front longitudinal position by means of the longitudinal adjustment device and pivoted forward by means of the rocker of the kinematic system, the stop being set into the stop position with the rocker of the kinematic system about a common axis of rotation and brought to bear against the first counter-stop face of the counter-stop. The stop may be supported against the counter-stop face of the counter-stop in order to absorb a force acting upon the backrest. A force, or load, is applied for example to the upper side of the backrest only in the front longitudinal positions, for example in the foremost longitudinal position of the vehicle seat. The stop may therefore be settable into the stop position or activatable in a front longitudinal position of the vehicle seat and/or only in the foremost longitudinal position.

To provide the emergency exit, the stop of the entry position stop is prevented from rotating into a stop position. The free-running allows the stop to be turned in a direction opposite to the stop position.

In the emergency exit position, the vehicle seat may be moved over the position of the counter-stop in any longitudinal position and pivoted forward. In the moving over the position of the counter-stop, the rocker of the kinematic system may be pivoted forward about the axis of rotation, and the stop may be arranged in a region above the counter-stop and set into the free-running position by bearing against the second counter-stop face of the counter-stop, about the axis of rotation. Due to the free-running, the stop may be arranged on the pivot joint of the rocker and can be guided concomitantly. The stop can be fastened compactly and with fewer components to the vehicle seat, in particular to the kinematic system.

The stop may comprise at least one stop pawl and a stop holder, and the stop pawl may be mounted so as to be pivotable on the rocker by means of the stop holder. The stop holder may be fixedly connected to the rocker. The stop holder may be a retaining ring, for example. The stop holder may, for example, be welded and/or adhesively bonded to the rocker.

To provide the emergency exit, the stop pawl is prevented, for example, from rotating into a stop position, the stop pawl, in the emergency exit position, being able to rotate in a free-running relative to the stop holder. The stop may be fastened with free-running to a lower pivot point of the kinematic system, in particular the rocker. In particular, the stop holder may be fixed to the lower pivot point of the rocker, and the stop pawl may be mounted on the stop holder so as to be pivotable relative to it.

The stop pawl may comprise at least one axially projecting stop cam, which is operatively connected to at least one radially projecting counter-stop cam of the stop holder.

The stop pawl may comprise at least one radially projecting stop arm, which can be brought to bear against the counter-stop. The stop arm of the stop pawl may be provided with a buffer element.

The stop may comprise at least one reset element that is configured to bias the stop pawl, relative to the stop holder, in the initial position. For example, the free-running may be spring-loaded.

### DESCRIPTION OF THE FIGURES

The invention is described in greater detail below on the basis of exemplary embodiments that are represented in the figures. However, the invention is not limited to these exemplary embodiments. In the figures:

FIG. 1: shows a schematic representation of a vehicle seat having a longitudinal adjustment device according to the prior art,

FIG. 2: shows a side view of a vehicle seat according to the invention in an entry position, the vehicle seat comprising at least one seat part, a backrest, a kinematic system for shifting the vehicle seat from a position of use into the entry position, a longitudinal adjustment device and at least one entry position stop,

FIG. 3: shows a partial perspective view of the vehicle seat according to the invention in an entry position,

FIG. 4: shows a further partial perspective view of the vehicle seat according to the invention in the entry position,

FIG. 5: shows a partial perspective view of the vehicle seat according to the invention in the seat position (also known as design position) and an exploded view of a stop of the entry position stop,

FIG. 6: shows a perspective view of a stop pawl of the stop,

FIGS. 7 to 9: show a sequence in which the vehicle seat according to the invention is shifted from its position of use into the entry position, and

FIGS. 10 and 11: show a sequence in which the vehicle seat according to the invention is shifted into an emergency exit position from a foremost longitudinal setting.

### DETAILED DESCRIPTION

In all figures, mutually corresponding parts are denoted by the same reference designations.

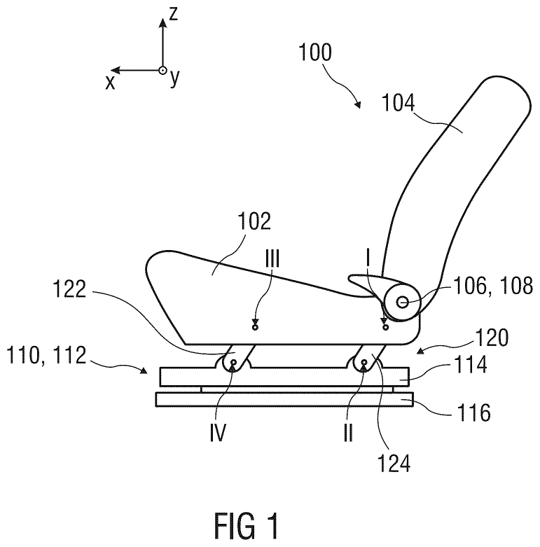

A vehicle seat 100 represented schematically in FIG. 1 with regard to the prior art is described below using three mutually perpendicular spatial directions. In the case of a vehicle seat 100 installed in the vehicle, a longitudinal direction x runs largely horizontally and preferably parallel to a longitudinal direction of the vehicle, which corresponds to the usual direction of travel of the vehicle. A transverse direction y running perpendicular to the longitudinal direction x is likewise oriented horizontally in the vehicle and runs parallel to a transverse direction of the vehicle. A vertical direction z runs perpendicular to the longitudinal direction x and perpendicular to the transverse direction y. In the case of a vehicle seat 100 installed in the vehicle, the vertical direction z preferably runs parallel to a vertical axis of the vehicle.

The positional and directional indications used, such as, for example, front, rear, upper and lower, relate to a direction of view of an occupant sitting in the vehicle seat 100 in a normal seated position, the vehicle seat 100 being installed in the vehicle, in a position of use suitable for passenger transport, with the backrest 104 vertically upright and orientated as usual in the direction of travel. However, the vehicle seat 100 may also be fitted or moved in a different orientation, for example transverse to the direction of travel. Unless otherwise described, the vehicle seat 100 is constructed mirror symmetrically with respect to a plane that is perpendicular to the transverse direction y.

The backrest 104 may be arranged so as to be pivotable on a seat part 102 of the vehicle seat 100. For this purpose, the vehicle seat 100 may optionally comprise a fitting 106, in particular a setting fitting, rotary fitting, latching fitting or wobble fitting. The positional and directional indications used, such as, for example, radial, axial and circumferential, relate to an axis of rotation 108 of the fitting 106. Radial means perpendicular to the axis of rotation 108. Axial means in the direction of or parallel to the axis of rotation 108.

The vehicle seat 100 may optionally comprise a longitudinal adjustment device 110. The longitudinal adjustment device 110 comprises, for example, a rail arrangement 112 having a first rail element 114 and a second rail element 116. The first rail element 114 is adjustable relative to the second rail element 116 in the longitudinal direction x. The first rail element 114 is fastened to the seat part 102. The second rail element 116 is fastened to a structural element of a vehicle, for example a vehicle floor.

For greater clarity, the first rail element 114 is referred to in the following description as a movable rail 114 or upper rail 114. This upper rail 114 (also called running rail or slide) is assigned to the vehicle seat 100 and is configured to support this vehicle seat 100. The second rail element 116 is referred to below as a fixed rail 116 or lower rail 116. The lower rail 116 is fixed and connected, for example, to the floor of a vehicle.

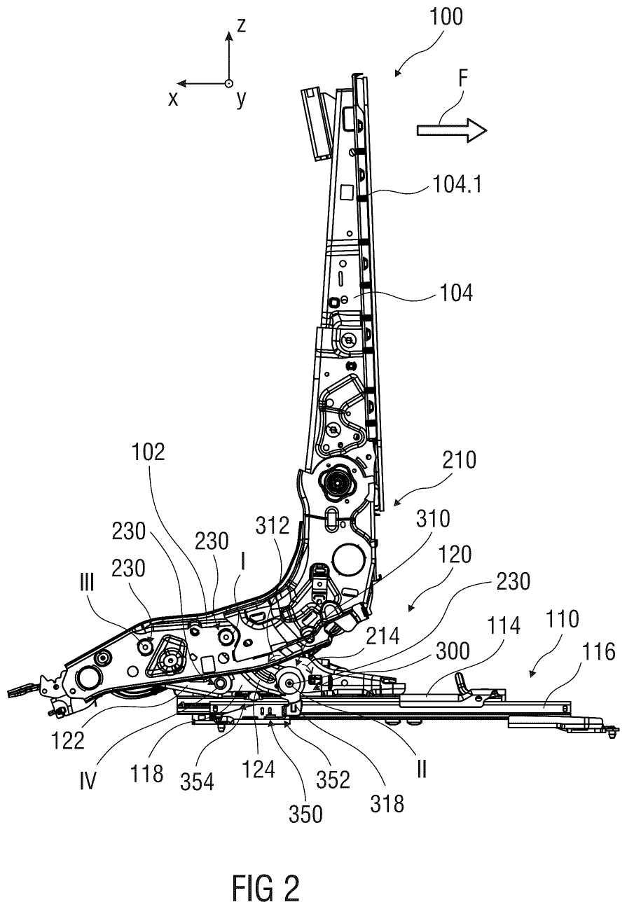

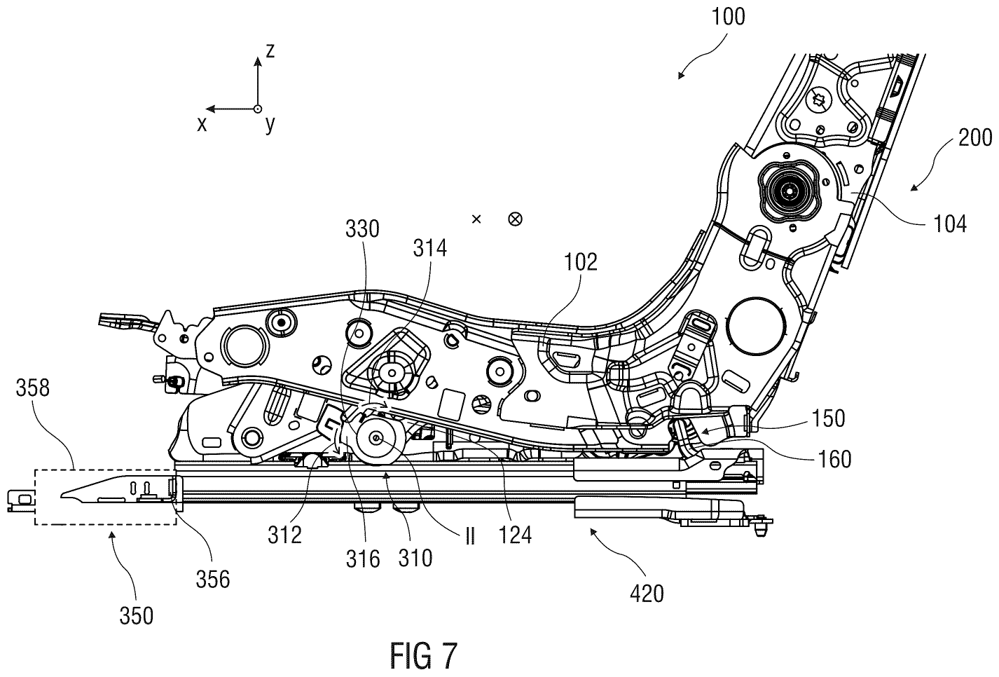

Furthermore, arranged between the vehicle seat 100, in particular between the seat part 102 and the longitudinal adjustment device 110 and/or a vehicle floor, there is a kinematic system 120 for shifting the vehicle seat 100 from a position of use 200, as shown in FIG. 7, into an entry position 210 (easy-entry position), as shown in FIG. 2. The position of use 200 is used to transport at least one seat occupant. The entry position 210 allows convenient access to a row of seats arranged behind the vehicle seat 100.

The kinematic system 120 may have at least two rockers 122, 124, each rocker 122, 124 having two ends. There is a respective pivot joint I, II, III, IV provided in the region of these ends.

FIG. 2 shows a side view of a vehicle seat 100 according to the invention, comprising at least one seat part 102, a backrest 104, a kinematic system 120 for shifting the vehicle seat 100 from a position of use 200 (shown in FIG. 7) into an entry position 210 and back again, a longitudinal adjustment device 110 for longitudinally adjusting the vehicle seat 100, and at least one entry position stop 300. The entry position stop 300 in this case is configured to absorb, in the entry position 210, a force F acting upon the backrest 104 and to run freely for the purpose of providing an emergency exit.

Since the entry position stop 300 is configured to absorb a force acting upon the backrest 104, in particular on an upper side 104.1 or upper edge of the backrest 104, in the entry position 210, the kinematic system 120 can be relieved of forces F acting upon the backrest 104. The backrest 104 may have a load absorption demand of, for example, 650 N for sustained entry/exit.

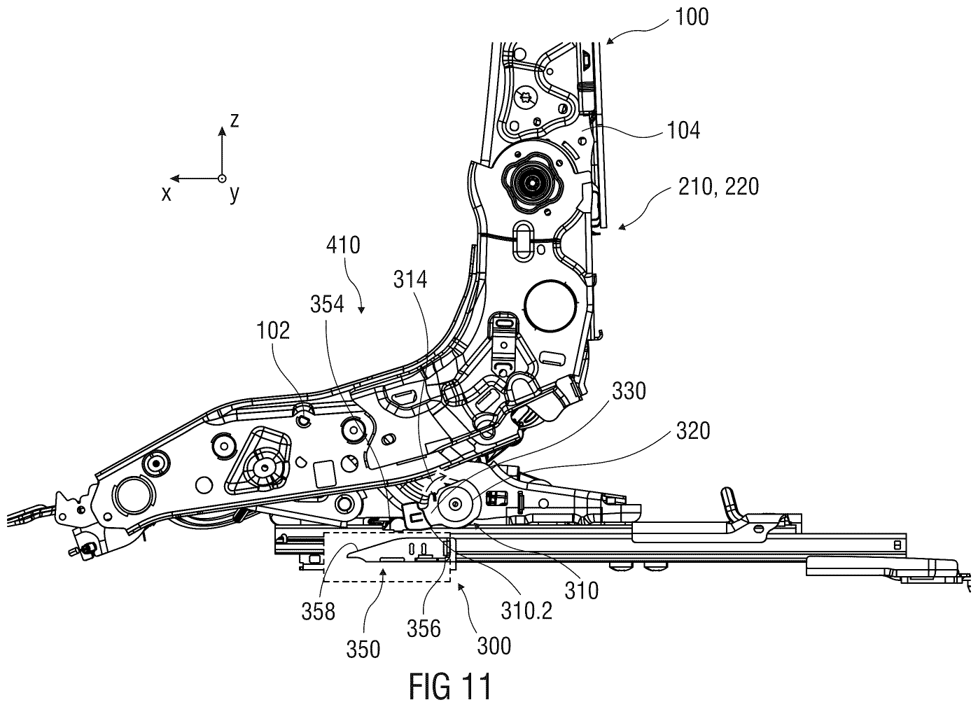

Since the entry position stop 300 is configured to run freely for the purpose of providing an emergency exit, the shifting of the vehicle seat 100 into an entry position 210 and into an emergency exit position 220, as shown in FIG. 11, can be ensured with the vehicle seat 100 being in any position. Such free-running of the entry position stop 400 prevents the shifting of the vehicle seat 100 from the position of use 200 into the entry position 210, or into the emergency exit position 220, from being blocked.

The seat part 102 may be articulated to a foot 118 and/or to the movable rail element 114 by means of the rockers 122, 124 of the kinematic system 120. The foot 118, the rockers 122, 124 and the seat part 102 may form a four-bar arrangement. The kinematic system 120 may have a respective four-bar arrangement on both sides of the seat part 102.

The foot 118 is fixedly connected to the movable rail element 114. The seat part 102 is articulated to the foot 118 by means of a rear rocker 124. The rear rocker 124 has two ends, a pivot joint I, II being provided in the region of each of these two ends, of which a first pivot joint I forms an articulation of the rocker 124 on a rear portion of the seat part 102, and a second pivot joint II forms an articulation of the rocker 124 on the foot 118. The rear rocker 124 may form a link.

The seat part 102 is articulated to the foot 118 by means of a front rocker 122. The front rocker 122 has two ends, a pivot joint III, IV being provided in the region of each of these two ends. A third pivot joint III forms an articulation of the rocker 122 to a front portion of the seat part 102, and a fourth pivot joint IV forms an articulation of the rocker 122 to the foot 118.

The pivot joints I, II, III, IV each define an axis of rotation 230.

The vehicle seat 100 is movable by means of the kinematic system 120 along a predefined path of movement from the position of use 200 into the entry position 210 and back again.

The entry position stop 300 comprises a stop 310 that is arranged so as to be pivotable on one of the rockers 122, 124, in particular on the rear rocker 124, of the kinematic system 120. The entry position stop 300 comprises a counter-stop 350 that corresponds to the stop 310 and that can be brought to bear against the latter. The counter-stop 350 is fastened to the fixed rail element 116 of the longitudinal adjustment device 110 and/or to a vehicle floor.

The stop 310 is arranged at a lower end of the rear rocker 124. The stop 310 is articulated to the rocker 124 via the second pivot joint II. In particular, the stop 310 and the rear rocker 124 are jointly articulated to the foot 118 via the second pivot joint II. Rotation of the rocker 124 about the second pivot joint II renders the stop 310 concomitantly rotatable, or pivotable. The stop 310 is realized so as to be pivotable in a first direction 312 between an initial position 316, as represented in FIG. 7, and a stop position 318. The stop 310 is realized so as to be pivotable in a second direction 314, opposite to the first direction 312, between the initial position 316 and a free-running position 320. In particular, the stop 310 is realized so as to be pivotable about an axis of rotation 230 of the second pivot joint II of the rear rocker 124.

The counter-stop 350 is arranged in the region of a front longitudinal position 400, in particular a foremost longitudinal position 410, of the longitudinal adjustment device 110. The counter-stop 350 comprises a vertically extending first counter-stop face 352 and a horizontally extending second counter-stop face 354.

In normal operating mode, the vehicle seat 100 is displaceable in the entry position 210 into the front longitudinal position 400 by means of the longitudinal adjustment device 110, and is pivoted forward by means of the kinematic system 120. The stop 310 is set into the stop position 318 with the rear rocker 124 of the kinematic system 120 about the common axis of rotation 230. The stop 310 is thereby brought to bear against the first counter-stop face 352 of the counter-stop 350.

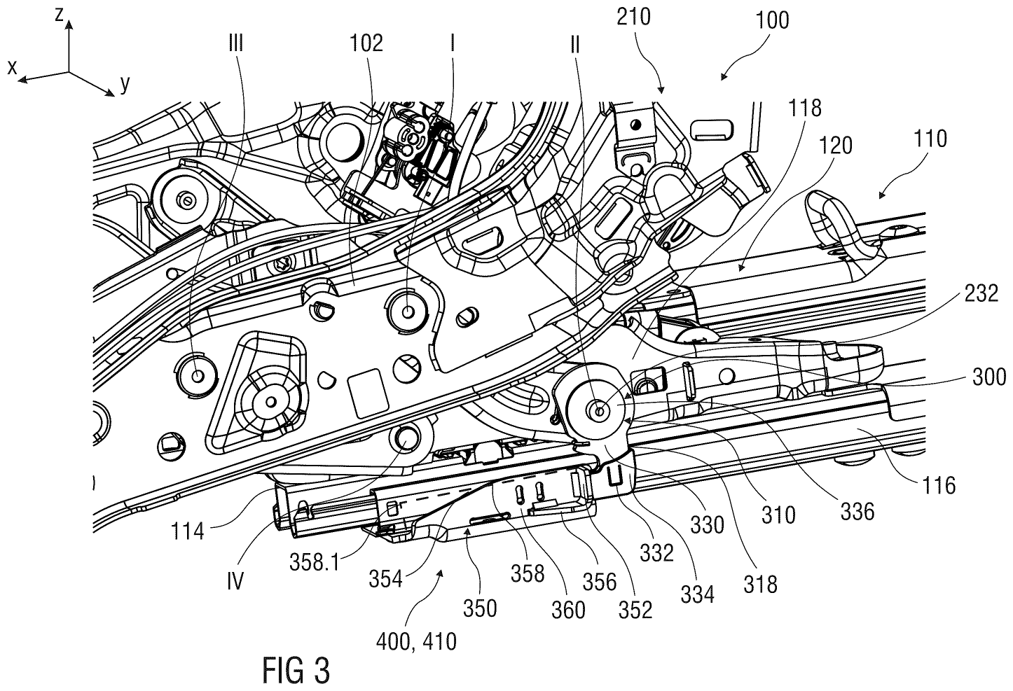

FIG. 3 shows a partial perspective view of the vehicle seat 100 according to the invention in an entry position 210.

The counter-stop 350 is arranged in the region of the foremost longitudinal position 410 of the longitudinal adjustment device 110. The counter-stop 350 is arranged at a rail end of the fixed rail element 116, in particular the lower rail 116. The counter-stop 350 comprises a vertically extending first counter-stop face 352 and a horizontally extending second counter-stop face 354. The counter-stop 350 may be realized in the form of a profiled element 356. For example, the counter-stop 350 may have a substantially L-shaped profiled element 356 to form the first counter-stop face 352 and/or the second counter-stop face 354. The vertically extending first counter stop face 352 may be realized by a leg of the profiled element 356. The counter-stop 350 may have a facing 358 for covering the profile element 356. The facing 358 may form the horizontally extending second counter stop face 354 along an upper wall 358.1. The counter-stop 350 may have a base body 360 fastened to the vehicle floor and/or to the lower rail 116. The profiled element 356 and the facing 358 may each be connected, for example welded, to each other and/or to the base body 360.

In normal operating mode, the vehicle seat 100 is displaced in the entry position 210 into the foremost longitudinal position 410 by means of the longitudinal adjustment device 110 and pivoted forward by means of the kinematic system 120. The stop 310 is set into the stop position 318 with the rear rocker 124 of the kinematic system 120 about the common axis of rotation 230. The stop 310 is thereby brought to bear against the first counter-stop face 352 of the counter-stop 350 in order to absorb a force F acting upon the backrest 104 and to relieve the kinematic system 120.

In the stop position 318, a stop pawl 330 of the stop 310 is pivoted forward. In particular, the stop pawl 330 in the stop position 318 extends substantially perpendicularly, for example with respect to a longitudinal axis x. The stop pawl 330 is realized so as to be pivotable about the second pivot joint II. In the initial position 316 (as shown in FIG. 7), the stop pawl 330 extends substantially horizontally or pivoted upward. The stop pawl 330 may be fastened, ‘wobble-fastened’ to the rocker 124. For example, the stop pawl 330 may be held so as to be pivotable on the pivot joint II, for example on a bearing pin 232 of the pivot joint II, by means of a disk attachment 336, for example in the form of a wobble disk.

The stop pawl 330 comprises at least one stop arm 332, which is provided with a buffer element 334. The buffer element 334 is, for example, an attachment formed from plastic. The buffer element 334 may be detachably connected to the stop arm 332. The buffer element 334 can be easily replaced for repair and/or maintenance of the vehicle seat 100.

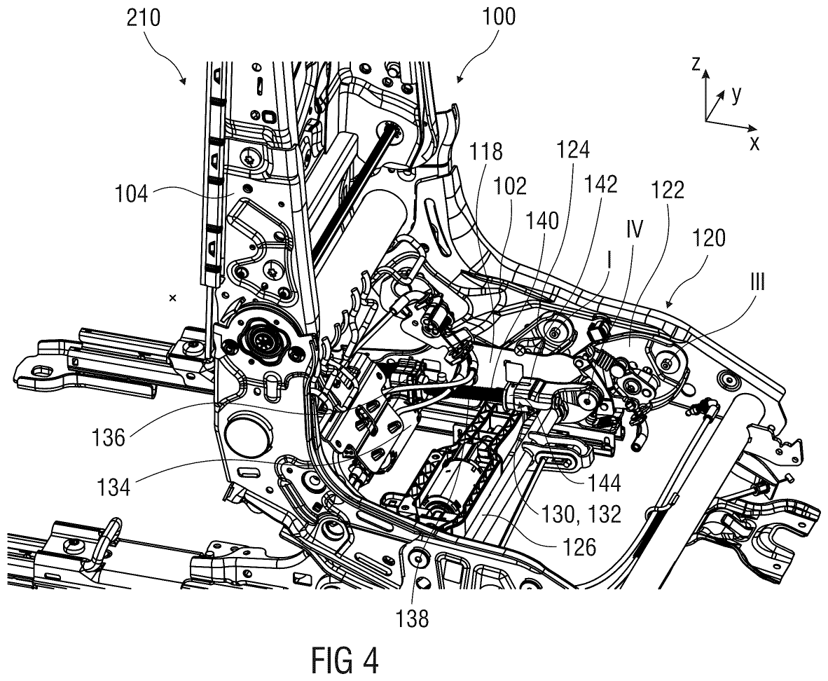

FIG. 4 shows a further perspective view of the vehicle seat 100 according to the invention in the entry position 210.

The front rocker 122 of a left-hand vehicle seat side can be connected to the front rocker 122 of a right-hand vehicle seat side via a transverse connection, here a transverse tube 126. The kinematic system 120 comprises at least one drive unit 130, here a spindle drive unit 132. The drive unit 130 has an electric motor 134 and a transmission 136 connected to the electric motor 134. Arranged on the output side of the transmission 136 there is spindle 138 that is drivable in rotation about a spindle axis 140 by means of the electric motor 134. The electric motor 134 is preferably held in a fixable manner in a counter-bearing relative to the foot 118 at the base of the vehicle seat 100. A rotational movement of the spindle 138 about the spindle axis 140 causes a spindle nut 144 held in a connection member 142 to be movable along the spindle 138 in the direction of the spindle axis 140. The spindle nut 144 moves translationally along the spindle 138 when the spindle 138 rotates.

In the entry position 210, a load acting upon the spindle drive unit 132, in particular upon the spindle 138, can be reduced by the entry position stop 300. Buckling of the spindle 138 can thereby be prevented.

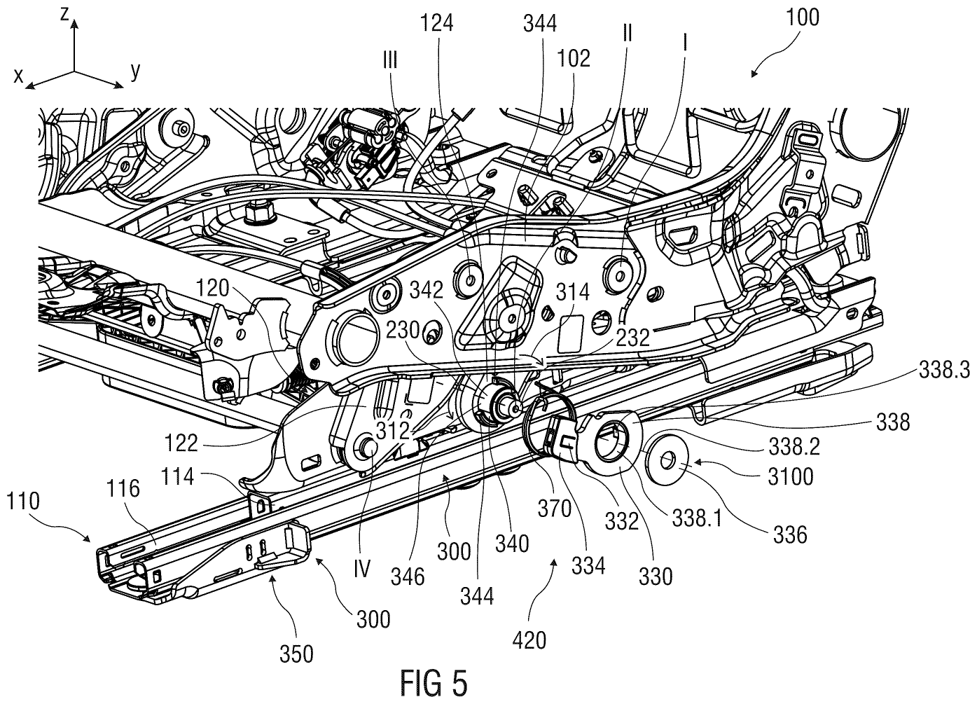

FIG. 5 shows a perspective view of the vehicle seat 100 according to the invention and an exploded view of a stop 310 of the entry position stop 300. The vehicle seat 100 is shown in a position of use 200 in a rear longitudinal position 420.

The stop 310 comprises a stop pawl 330 and a stop holder 340. The stop pawl 310 comprises an annular stop body 338 and an opening 338.1 for receiving the bearing pin 232 of the pivot joint II. A pivot axis 338.2 of the stop pawl 330 is in alignment with the axis of rotation 230 of the pivot joint II. The stop pawl 330 is pivotably mounted on the rocker 124 by means of the stop holder 340. The stop holder 340 is fixedly connected to the rocker 124. The stop holder 340 may be, for example, a retaining ring. In particular, the stop holder 340 is welded to a lower end of the rocker 124.

The stop pawl 330 comprises at least one stop arm 332 that projects radially from the stop body 338 and that can be brought to bear against the counter-stop 350. The stop arm 332 is provided with a buffer element 334.

The stop 330 comprises at least one reset element 370 that is configured to bias the stop pawl 330 relative to the stop holder 340 in the initial position 316. For example, free-running may be spring-loaded. The reset element 370 may be a spring, for example a leg spring. In particular, the reset element 370 is configured to bias the stop pawl 330 in the first direction 312, in which the stop pawl 330 is settable to assume the stop position 318. When the stop pawl 330 is pivoted in the second direction 314, in which the stop pawl 330 can run freely, the stop pawl 330 is moved counter to a reset force of the reset element 370.

In order to ensure positioning of the stop pawl 330 on the stop holder 340, the stop pawl 330 comprises at least one stop cam 338.3, here, in the exemplary embodiment represented, two stop cams 338.3 arranged at a distance from one another. The stop cams 338.3 project axially inward from the stop body 338. The stop holder 340 comprises at least one counter-stop cam 344 projecting from an annular retaining body 342. In the exemplary embodiment represented, the stop holder 340 comprises two counter-stop cams 344 corresponding to the stop cams 338.3 of the stop pawl 330. The counter-stop cams 344 are arranged at a distance from one another. In particular, a free-running path 346 is defined by a distance between two ends of the counter-stop cams 344. An assigned stop cam 338.3 of the stop pawl 330 can move freely between the two counter-stop cams 344, which are realized, for example, as ring segments. The free-running path 346 may predefine a free-running of, for example, 80°. In the initial position 316 and in normal operating mode, the respective stop cam 338.3 is applied to a corresponding end of one of the counter-stop cams 344 by a spring force of the reset element 370. The reset element 370 is configured to press the stop pawl 330 against the radially projecting counter-stop cams 344 of the stop holder 340. As a result, a rotational movement of the stop holder 340 initiated by the rocker 124 can cause the stop pawl 330 to pivot.

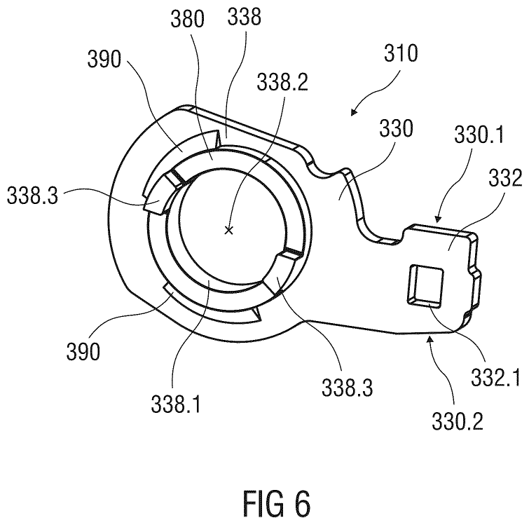

FIG. 6 shows a perspective view of a stop pawl 330 of the stop 310.

The stop pawl 330 comprises at least one stop arm 332, which may be detachably provided with a buffer element 334. For this purpose, the stop arm 332 has a cut-out 332.1 into which a fastening element of the buffer element 334, for example of a two-part buffer element 334, can be inserted. The stop 310 comprises a stop pawl 330, which has an annular stop body 338 and an opening 338.1 for receiving the bearing pin 232 of the pivot joint II. A pivot axis 338.2 of the stop pawl 330 is in alignment with the axis of rotation 230 of the pivot joint II. The stop pawl 330 comprises two stop cams 338.3 arranged radially spaced apart from one another. The stop cams 338.3 project axially from the stop body 338 and may be realized as ring segments. The stop cams 338.3 may be realized on a separate ring 380. This ring 380 may be fastened to the stop body 338 via connection points 390, for example welds and/or soldered joints. The stop pawl 330, in particular the stop arm 332, comprises a first stop face 330.1 and, opposite the latter, a second stop face 330.2. The first stop face 330.1 can be brought to bear against the first counter-stop face 352 of the counter-stop 350 for the purpose of absorbing a force F acting upon the backrest 104. The second stop face 330.2 can be brought to bear against the second counter-stop face 354 of the counter-stop 350 in order to move the stop 310, in particular the stop pawl 330, along the free-running path 346 and to set it into the free-running position 320 (as shown in FIG. 11).

FIGS. 7 to 9 show a sequence in which the vehicle seat 100 according to the invention is shifted from its position of use 200 in to the entry position 210.

Here, FIG. 7 shows the vehicle seat 100 in a rear longitudinal position 420 and position of use 200. When the vehicle seat 100 is in the position of use 200, the stop 310 is positioned in the initial position 316. The stop 310 is designed so as to be pivotable in a first direction 312 between an initial position 316, as shown in FIG. 7, and a stop position 318. The stop 310 is realized so as to be pivotable in a second direction 314, opposite to the first direction 312, between the initial position 316 and a free-running position 320. In particular, the stop 310 is realized so as to be pivotable about an axis of rotation 230 of the second pivot joint II of the rear rocker 124. The seat part 102 may be releasably locked to a base by means of a lock 150 attached to a vehicle floor and/or to the movable rail 114, more specifically to a locking element fixed to the base, here a lock shackle 160 fastened to the movable rail 114.

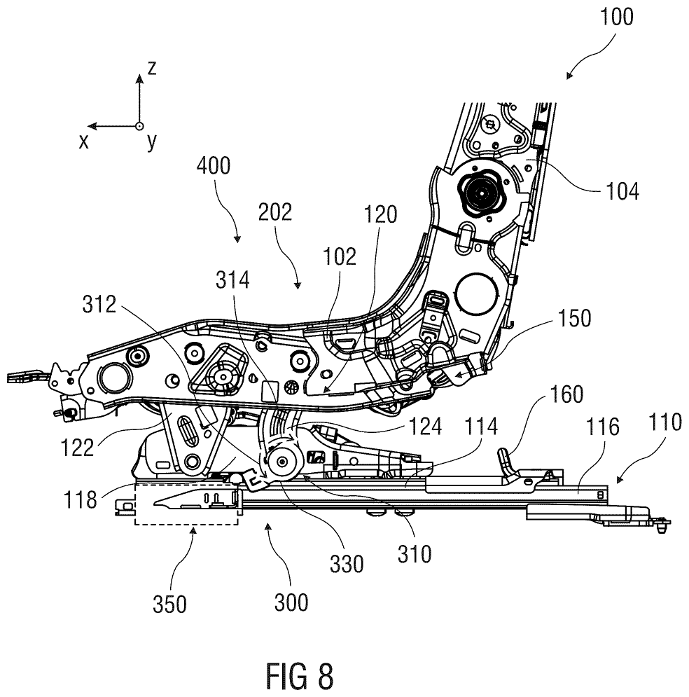

FIG. 8 shows the vehicle seat 100 in an intermediate position 202. In the intermediate position 202, the vehicle seat 100 has been moved from the rear longitudinal position 420 into a front longitudinal position 400 and partially pivoted upward and/or forward. In this process, the stop 310 has been moved, in particular pivoted, together with the rear rocker 124 in the first direction 312. The upper movable rail 114 and the kinematic system 120, in particular the rockers 122, 124, may be moved electronically in parallel or sequentially. In this intermediate position 202, the stop 310 can be moved from the initial position 316 into the stop position 318 without colliding with the counter-stop 350.

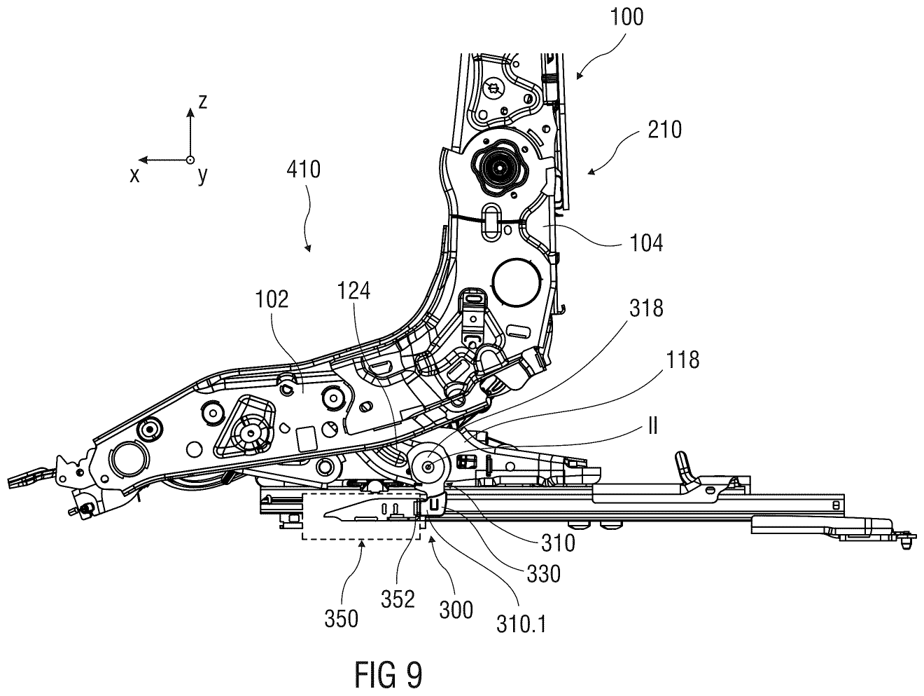

FIG. 9 shows the vehicle seat 100 in the entry position 210. In the entry position 210, the vehicle seat 100 is moved, for example, into the foremost longitudinal position 410 and pivoted fully forward. When the vehicle seat is in the entry position 210, the stop 310, in particular the stop pawl 330, is pivoted with the rear rocker 124 about the common axis of rotation 230 and set into the stop position 318. In the process, the first stop face 310.1 is brought to bear against the first counter-stop face 352 of the counter-stop 350. The stop 310 can bear against the counter-stop face 352 of the counter-stop 350 in order to absorb a force F acting upon the backrest 104.

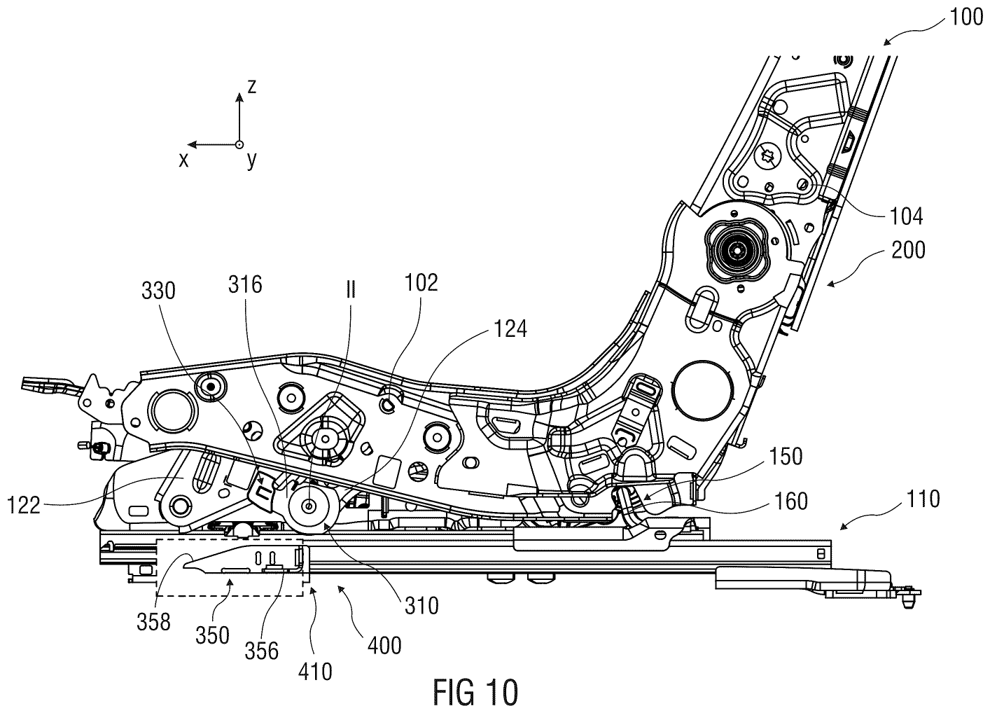

FIGS. 10 and 11 show a sequence in which the vehicle seat 100 according to the invention is shifted from the position of use 200 (=design position) into an emergency exit position 220.

In the event of an emergency exit following an accident or power failure, the electrified rail arrangement 112 used here, in particular the upper rail 114, is no longer displaceable.

In the case of an emergency exit, the emergency exit may be performed from any previous longitudinal seat position (position of use 200 or other position) by means of the free travel 346 (represented in FIG. 5). The stop 310 in this case does not hinder the emergency exit, as it is rotated away by contact with the facing 358 (also referred to as the cover for short) on the upper rail 114.

This means that, in the case of an emergency exit, the upper rail 114 is not displaced. Consequently, also, no new longitudinal position 400, 410, 420 beyond the currently set longitudinal position 400, 410, 420 is assumed.

FIG. 10 shows the vehicle seat 100 in a position of use 200 in which, for the purpose of shifting the vehicle seat 100 into the emergency exit position 220 (as shown in FIG. 11), the lock shackle 160, locked by means of the lock 150, is displaced forward, in particular beyond the foremost longitudinal position 410. Since the vehicle seat 100 is in the position of use 200, the stop 310, in particular the stop pawl 330, remains in the initial position 316. The stop 310 can thus be movable with the vehicle seat 100 beyond a position of the counter-stop 350. As a result, the stop 310 can pass over the counter-stop 350, comprising at least the profiled element 356 and the facing 358, without collision or blocking.

FIG. 11 shows the vehicle seat 100 in the emergency exit position 220, which corresponds to the normal entry position 210. The vehicle seat is set into the foremost longitudinal position 410.

When the vehicle seat 100 is in the emergency exit position 220, the rear rocker 124 is pivoted forward about the axis of rotation 230, with the stop 310 arranged in a region above the counter-stop 350. As a result of the second stop face 310.2 of the stop 310 bearing against the second counter-stop face 354 of the counter-stop 350, the stop 310 is pressed, counter the direction of rotation of the rear rocker 124, into the free-running position 320. In order to prevent the stop 310 and the counter-stop 350 from coming into blocking or obstructive contact in any longitudinal position 400, 410 in which the vehicle seat 100 is to be shifted from its position of use 200 into the entry position 210, for example in the case of a manual emergency exit, it is provided according to the invention that the stop 310 can run freely for the purpose of providing the emergency exit. In this case, the stop 310 is moved away counter to a direction of rotation of the rockers 122, 124 and into free-running. This enables the vehicle seat 100 to be shiftable from the position of use 200 into the entry position 210, or into the emergency exit position 220, in any longitudinal position 400, 410 (in FIG. 11, in the foremost longitudinal position 410).

### LIST OF REFERENCE DESIGNATIONS

100 vehicle seat

102 seat part

104 backrest

104.1 upper side

106 fitting

108 axis of rotation

110 longitudinal adjustment device

112 rail arrangement

114 first rail element (upper rail)

116 second rail element (lower rail)

118 foot

120 kinematic system

122 rocker, in particular front rocker

124 rocker, in particular rear rocker

126 transverse tube

130 drive unit

132 spindle drive unit

134 electric motor

136 transmission

138 spindle

140 spindle axis

142 connection member

144 spindle nut

150 lock

160 lock shackle

200 position of use

202 intermediate position

210 entry position

220 emergency exit position

230 axis of rotation

232 bearing pin

300 entry position stop

310 stop

312 first direction

314 second direction

316 initial position

318 stop position

320 free-running position

330 stop pawl

330.1 first stop face

330.2 second stop face

332 stop arm

334 buffer element

336 disk attachment

338 stop body

338.1 opening

338.2 pivot axis

338.3 stop cam

340 stop holder

342 retaining body

344 counter-stop cam

346 free-running path

350 counter-stop

352 first counter-stop face

354 second counter-stop face

356 profiled element

358 facing

360 base body

370 reset element

380 ring

390 connection point

400, 410, 420 longitudinal position

I, II, III, IV pivot joint

x longitudinal direction

y transverse direction

z vertical direction

1. A vehicle seat, comprising:
a seat part,
a backrest,
a kinematic system for shifting the vehicle seat from a position of use into an entry position and back again,
a longitudinal adjustment device for longitudinally adjusting the vehicle seat, and
an entry position stop that is configured to absorb a force acting upon the backrest in the entry position and to run free to provide an emergency exit.

2. The vehicle seat as claimed in claim 1, wherein the entry position stop comprises at least one stop that is arranged in a pivotable manner on a rocker of the kinematic system and at least one counter-stop that is connected to a fixed rail element of the longitudinal adjustment device.

3. The vehicle seat as claimed in claim 2, wherein the at least one stop is pivotable in a first direction from an initial position into a stop position, and in a second direction from the initial position into a free-running position.

4. The vehicle seat as claimed in claim 2, wherein the counter-stop is arranged in the region of a front longitudinal position of the longitudinal adjustment device, and comprising at least a vertically extending first counter-stop face and a horizontally extending second counter-stop face.

5. The vehicle seat as claimed in claim 4, wherein in the entry position the vehicle seat is displaced into the front longitudinal position by means of the longitudinal adjustment device and pivoted forward by means of the kinematic system, the stop being set into the stop position with the rocker of the kinematic system and brought to bear against the first counter-stop face of the counter-stop.

6. The vehicle seat as claimed in claim 5, wherein in an emergency exit position, the vehicle seat is pivoted or pivotable forward in any longitudinal position by means of the kinematic system, the stop being arranged in a region above the counter-stop and set or settable into the free-running position by bearing against the second counter-stop face of the counter-stop, counter to the direction of rotation of the rocker.

7. The vehicle seat as claimed in claim 5, wherein the at least one stop comprises at least one stop pawl and a stop holder, the stop pawl being mounted so as to be pivotable on the rocker by means of the stop holder, the stop holder being fixedly connected to the rocker.

8. The vehicle seat as claimed in claim 7, wherein the stop pawl comprises at least one axially projecting stop cam, which can be or is rendered operatively connected to at least one radially projecting counter-stop cam of the stop holder.

9. The vehicle seat as claimed in claim 7, wherein the stop pawl comprises at least one radially projecting stop arm, which can be brought to bear against the counter-stop.

10. The vehicle seat as claimed in claim 7, wherein the stop comprises at least one reset element that is configured to bias the stop pawl, relative to the stop holder, in the initial position.
